(19) United States
(12) Patent Application Publication
(10) Pub. No.: US 2025/0103293 A1
(43) Pub. Date: Mar. 27, 2025

(54) ODD EXCEPTION HANDLING TO ACCURATELY CONVERT A SUM OF TWO UNIFORMLY WEIGHTED 2 TO THE (n-1)th POWER BITS WITH A (n-1) BIT ADC

(71) Applicant: QUALCOMM Incorporated, San Diego, CA (US)

(72) Inventors: Francois Ibrahim ATALLAH, Raleigh, NC (US); Yatharth GUPTA, Bangalore (IN)

(21) Appl. No.: 18/472,519

(22) Filed: Sep. 22, 2023

(51) Int. Cl. G06F 7/544; G06F 5/01

(52) U.S. Cl. CPC G06F 7/5443; G06F 5/01

(57) ABSTRACT

A method for multiplication and accumulation includes performing multiplications on a first set of bits and a second set of bits to generate first products, and performing multiplications on a third set of bits and a fourth set of bits to generate second products. The method also includes summing the first products to generate a first sum, changing a bit value of one of the second products, and summing the second products to generate a second sum. The method further includes averaging the first sum and the second sum to obtain an average of the first sum and the second sum, converting the average of the first sum and the second sum into a digital signal, and shifting and adding a one to the digital signal.

### BACKGROUND

### Field

Aspects of the present disclosure relate generally to analog-to-digital conversion, and more particularly to converting a sum of bits with an analog-to-digital converter.

### Background

An artificial intelligence (AI) accelerator or another type of processor may include multiply and accumulate circuits for performing multiply and accumulate (MAC) operations. A multiply and accumulate circuit may include a set of multipliers for performing multiple multiplications (e.g., bit-wise multiplications) in parallel, and an analog-to-digital converter for converting a sum of the resulting products into a digital signal.

### SUMMARY

The following presents a simplified summary of one or more implementations in order to provide a basic understanding of such implementations. This summary is not an extensive overview of all contemplated implementations and is intended to neither identify key or critical elements of all implementations nor delineate the scope of any or all implementations. Its sole purpose is to present some concepts of one or more implementations in a simplified form as a prelude to the more detailed description that is presented later.

A first aspect relates to a system. The system includes first multipliers configured to perform multiplications on a first set of bits and a second set of bits to generate first products, and second multipliers configured to perform multiplications on a third set of bits and a fourth set of bits to generate second products. The system also includes a parity compare circuit coupled to the first multipliers and the second multipliers, wherein the parity compare circuit is configured to generate a parity compare signal indicating whether a number of ones in the first products and a number of ones in the second products have a same parity or different parities. The system also includes a conversion circuit configured to change a bit value of one of the second products if the parity compare signal indicates the number of ones in the first products and the number of ones in the second products have the different parities. The system further includes a first summer configured to sum the first products to generate a first sum, a second summer configured to sum the second products to generate a second sum, a switching circuit coupled to the first summer and the second summer, an analog-to-digital converter (ADC) coupled to the switching circuit, and a shift and add circuit coupled to the ADC.

A second aspect relates to a method for multiplication and accumulation. The method includes performing multiplications on a first set of bits and a second set of bits to generate first products, and performing multiplications on a third set of bits and a fourth set of bits to generate second products. The method also includes summing the first products to generate a first sum, changing a bit value of one of the second products, and summing the second products to generate a second sum. The method further includes averaging the first sum and the second sum to obtain an average of the first sum and the second sum, converting the average of the first sum and the second sum into a digital signal, and shifting and adding a one to the digital signal.

A third aspect relates to a machine learning accelerator. The machine learning accelerator includes a memory, and a multiply and accumulate array coupled to the memory, wherein the multiply and accumulate array includes multiply and accumulate circuits. Each of the multiply and accumulate circuits includes respective first multipliers configured to perform multiplications on a respective first set of bits and a respective second set of bits to generate respective first products, and respective second multipliers configured to perform multiplications on a respective third set of bits and a respective fourth set of bits to generate respective second products. Each of the multiply and accumulate circuits also includes a respective parity compare circuit coupled to the respective first multipliers and the respective second multipliers, wherein the respective parity compare circuit is configured to generate a respective parity compare signal indicating whether a number of ones in the respective first products and a number of ones in the respective second products have a same parity or different parities. Each of the multiply and accumulate circuits also includes a respective conversion circuit configured to change a bit value of one of the respective second products if the respective parity compare signal indicates the number of ones in the respective first products and the number of ones in the respective second products have the different parities. Each of the multiply and accumulate circuits further includes a respective first summer configured to sum the respective first products to generate a respective first sum, a respective second summer configured to sum the respective second products to generate a respective second sum, a respective switching circuit coupled to the respective first summer and the respective second summer, a respective analog-to-digital converter (ADC) coupled to the respective switching circuit, and a respective shift and add circuit coupled to the respective ADC.

### BRIEF DESCRIPTION OF THE DRAWINGS

FIG. 1 shows an example of a multiply and accumulate circuit according to certain aspects of the present disclosure.

FIG. 2 shows an example of a multiply and accumulate circuit configured to sum two 2⁽ⁿ⁻¹⁾ products with a (n−1) analog-to-digital converter (ADC) according to certain aspects of the present disclosure.

FIG. 3 shows an example of the multiply and accumulate circuit with odd exception handling according to certain aspects of the present disclosure.

FIG. 4 is a flowchart illustrating a method of converting a sum of products into a digital signal for cases where the sum is odd according to certain aspects of the present disclosure.

FIG. 5 shows an exemplary implementation of a shift and add circuit according to certain aspects of the present disclosure.

FIG. 6 shows an example of a multiply and accumulate circuit including latches according to certain aspects of the present disclosure.

FIG. 7 shows an example of a timing diagram of exemplary signals in the multiply and accumulate circuit of FIG. 6 according to certain aspects of the present disclosure.

FIG. 8 shows an exemplary implementation of a parity compare circuit according to certain aspects of the present disclosure.

FIG. 9 shows an exemplary implementation of a conversion circuit according to certain aspects of the present disclosure.

FIG. 10 shows an exemplary implementation of a lagging one detector according to certain aspects of the present disclosure.

FIG. 11 shows an example of a multiply and accumulate system including multiple instances of the multiply and accumulate circuit according to certain aspects of the present disclosure.

FIG. 12 shows an example of a machine learning accelerator according to certain aspects of the present disclosure.

FIG. 13 is a flowchart illustrating a method for multiplication and accumulation according to certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

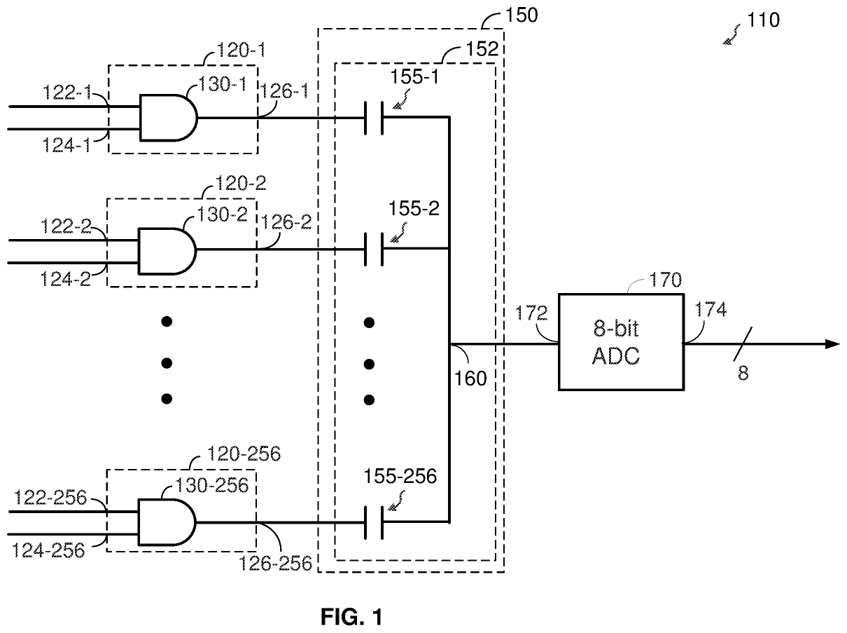

FIG. 1 shows an example of a multiply and accumulate circuit 110 according to certain aspects of the present disclosure. The multiply and accumulate circuit 110 is configured to perform 2ⁿ bit-wise multiplications on a first set of 2ⁿ bits and a second set of 2ⁿ bits to generate 2ⁿ one-bit products, sum the 2ⁿ one-bit products, and convert the sum into an n-bit digital signal, as discussed further below. As used herein, a one-bit product is a product having a single bit value of one or zero. In the example illustrated in FIG. 1, n is eight for purposes of discussion.

The multiply and accumulate circuit 110 includes 2ⁿ bit-wise multipliers 120-1 to 120-256, a summer 150, and an n-bit analog-to-digital converter (ADC) 170. In the example in FIG. 1, each of the multipliers 120-1 to 120-256 is implemented with a respective AND gate 130-1 to 130-256. However, it is to be appreciated that the multipliers 120-1 to 120-256 are not limited to this exemplary implementation.

Each of the multipliers 120-1 to 120-256 has a respective first input 122-1 to 122-256, a respective second input 124-1 to 124-256, and a respective output 126-1 to 126-256. The first input 122-1 to 122-256 of each of the multipliers 120-1 to 120-256 is configured to receive a respective one of the bits of the first set of 2ⁿ bits, and the second input 124-1 to 124-256 of each of the multipliers 120-1 to 120-256 is configured to receive a respective one of the bits of the second set of 2ⁿ bits. Each of the multipliers 120-1 to 120-256 is configured to perform bit-wise multiplication on the respective bits to generate a respective one-bit product. As a result, the multipliers 120-1 to 120-256 output 2ⁿ one-bit products at the outputs 126-1 to 126-256.

In certain aspects, each of the multipliers 120-1 to 120-256 is configured to output a voltage approximately equal to zero volts (i.e., ground potential) to represent a product of zero (i.e., logic zero), and output a voltage approximately equal to Vdd to represent a product of one (i.e., logic one), where Vdd is a supply voltage.

The summer 150 is configured to sum the 2ⁿ one-bit products from the multipliers 120-1 to 120-256 in the analog voltage domain, as discussed further below. In the example in FIG. 1, the summer 150 includes a capacitor array 152 including 2ⁿ capacitors 155-1 to 155-256, in which each of the capacitors 155-1 to 155-256 is coupled between the output 126-1 to 126-256 of a respective one of the multipliers 120-1 to 120-256 and a summing node 160. The capacitors 155-1 to 155-256 may have equal capacitances (e.g., for uniformly weighted products).

In operation, the summer 150 is configured to generate a voltage at the summing node 160 approximately equal to the following:

$$voltage\_sum = [ sum / {2}^{n} ] * Vdd \qquad ( 1 )$$

where sum is the sum of the 2ⁿ one-bit products, Vdd is the supply voltage, and voltage_sum is the voltage at the summing node 160. For example, if half the products have a bit value of one, then the voltage at the summing node 160 is approximately equal to half Vdd, which represents a sum of 128 for the example where n is eight.

The ADC 170 has an input 172 and an output 174, in which the input 172 is coupled to the summing node 160 of the summer 150. The ADC 170 may be implemented with a successive approximation register (SAR) ADC or another type of ADC. The ADC 170 is configured to convert the voltage at the summing node 160 into an n-bit digital signal indicating the sum of the products of the multipliers 120-1 to 120-256. For example, if the products include 128 ones (i.e., half the products are one), then the voltage at the summing node 160 is equal to half Vdd and the n-bit digital signal output by the ADC 170 indicates a sum of 128.

It is desirable to reduce the power consumption of the multiply and accumulate circuit 110. For example, reducing the power consumption of the multiply and accumulate circuit 110 can lead to a significant reduction in a system including many instances of the multiply and accumulate circuit 110.

One option to reduce power consumption is to implement the ADC 170 with an (n−1) ADC instead of an n-bit ADC. This reduces the power consumption of the ADC 170, which reduces the overall power consumption of the multiply and accumulate circuit 110. However, implementing the ADC 170 with an (n−1) ADC in the exemplary architecture shown in FIG. 1 significantly degrades accuracy. This is because the voltage at the summing node 160 has 2ⁿ possible voltage levels (e.g., 256 possible voltage levels) corresponding to 2ⁿ possible values for the sum of the 2ⁿ products. As a result, the ADC 170 requires a bit resolution of n bits to accurately convert the voltage at the summing node 160 into an n-bit digital signal at the output 174. This precludes the use of an (n−1) bit ADC to reduce power consumption in the architecture of FIG. 1.

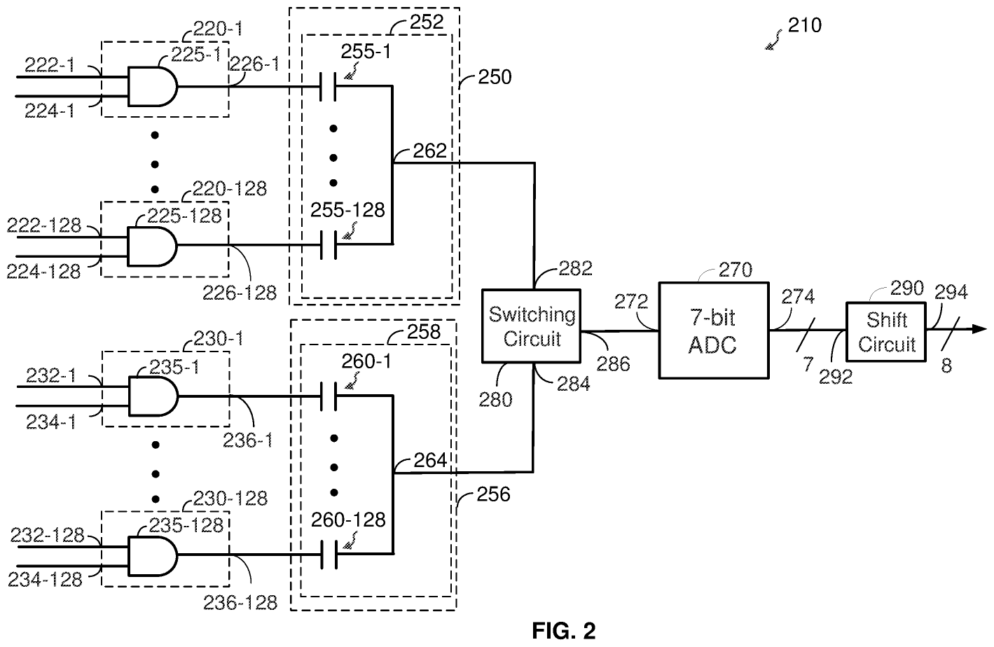

FIG. 2 shows an example of a multiply and accumulate circuit 210 configured to generate an n-bit digital signal indicating the sum of two 2⁽ⁿ⁻¹⁾ one-bit products using an (n−1) bit ADC 270 for reduced power according to certain aspects of the present disclosure. As discussed further below, further power reduction can be achieved by averaging the bits across two cycles of a clock signal and using the ADC 270 and downstream logic every other cycle of the clock signal in certain aspects. The exemplary multiply and accumulate circuit 210 is able to accurately convert the sum of two 2⁽ⁿ⁻¹⁾ one-bit products into an n-bit digital signal when the sum is even. In the example illustrated in FIG. 2, n is eight for purposes of discussion. However, it is to be appreciated that the present disclosure is not limited to this example, and that n may be another integer in other examples. A multiply and accumulate circuit may also be referred to as a multiplier and accumulator circuit, or another term.

Multiple instances (i.e., copies) of the multiply and accumulate circuit 210 may be used to perform multiply and accumulate (MAC) operations in an artificial intelligence (AI) accelerator. For example, the AI accelerator may include a large array of MAC circuits to perform a large number of MAC operations (e.g., to run AI models). However, it is to be appreciated that the multiply and accumulate circuit 210 is not limited to AI accelerators.

In the example in FIG. 2, the multiply and accumulate circuit 210 includes a first set of multipliers 220-1 to 220-128, a second set of multipliers 230-1 to 230-128, a first summer 250, a second summer 256, and a switching circuit 280. The multiply and accumulate circuit 210 also includes an ADC 270 and a shift circuit 290 (also referred to as a shifter). In this example, the ADC 270 is implemented with an (n−1) ADC instead of the n-bit ADC in FIG. 1, as discussed further below.

In the example in FIG. 2, the first set of multipliers 220-1 to 220-128 includes 2⁽ⁿ⁻¹⁾ multipliers and the second set of multipliers 230-1 to 230-128 includes 2⁽ⁿ⁻¹⁾ multipliers for a total of 2ⁿ multipliers. As discussed further below, the multipliers 220-1 to 220-128 are configured to perform 2⁽ⁿ⁻¹⁾ bit-wise multiplications on a first set of 2⁽ⁿ⁻¹⁾ bits and a second set of 2⁽ⁿ⁻¹⁾ bits to generate a first set of 2⁽ⁿ⁻¹⁾ products, and the multipliers 230-1 to 230-128 are configured to perform 2⁽ⁿ⁻¹⁾ bit-wise multiplications on a third set of 2⁽ⁿ⁻¹⁾ bits and a fourth set of 2⁽ⁿ⁻¹⁾ bits to generate a second set of 2⁽ⁿ⁻¹⁾ products. Thus, together, the multipliers 220-1 to 220-128 and 230-1 to 230-128 generate 2ⁿ products, where each product is one bit. For the example where n is eight, the first set of 2⁽ⁿ⁻¹⁾ products includes 128 products and the second set of 2⁽ⁿ⁻¹⁾ products includes 128 products for a total of 256 products. The multipliers 220-1 to 220-128 may also be referred to as the first multipliers and the multipliers 230-1 to 230-128 may also be referred to as the second multipliers. Also, the first set of 2⁽ⁿ⁻¹⁾ products may also be referred to as the first products, and the second set of 2⁽ⁿ⁻¹⁾ products may also be referred to as the second products.

Each of the multipliers 220-1 to 220-128 has a respective first input 222-1 to 222-128, a respective second input 224-1 to 224-128, and a respective output 226-1 to 226-128. The first input 222-1 to 222-128 of each of the multipliers 220-1 to 220-128 is configured to receive a respective one of the bits of the first set of bits, and the second input 224-1 to 224-128 of each of the multipliers 220-1 to 220-128 is configured to receive a respective one of the bits of the second set of bits. Each of the multipliers 220-1 to 220-128 is configured to perform multiplication on the respective bits to generate a respective one-bit product. The multipliers 220-1 to 220-128 output the first set of 2⁽ⁿ⁻¹⁾ products (i.e., first products) at the outputs 226-1 to 226-128. In this example, each of the multipliers 220-1 to 220-128 may output of voltage approximately equal to Vdd to represent a product with a bit value of one, and output a voltage approximately equal to zero volts (i.e., ground potential) to represent a product with a bit value of zero.

Each of the multipliers 230-1 to 230-128 has a respective first input 232-1 to 232-128, a respective second input 234-1 to 234-128, and a respective output 236-1 to 236-128. The first input 232-1 to 232-128 of each of the multipliers 230-1 to 230-128 is configured to receive a respective one of the bits of the third set of bits, and the second input 234-1 to 234-128 of each of the multipliers 230-1 to 230-128 is configured to receive a respective one of the bits of the fourth set of bits. Each of the multipliers 230-1 to 230-128 is configured to perform multiplication on the respective bits to generate a respective one-bit product. The multipliers 230-1 to 230-128 output the second set of 2⁽ⁿ⁻¹⁾ products (i.e., second products) at the outputs 236-1 to 236-128. In this example, each of the multipliers 230-1 to 230-128 may output of voltage approximately equal to Vdd to represent a product with a bit value of one, and output a voltage approximately equal to zero volts (i.e., ground potential) to represent a product with a bit value of zero.

The first summer 250 is configured to sum the first set of 2⁽ⁿ⁻¹⁾ products (i.e., first products) from the multipliers 220-1 to 220-128 to produce a first sum in the analog voltage domain, and the second summer 256 is configured to sum the second set of 2⁽ⁿ⁻¹⁾ products (i.e., second products) from the multipliers 230-1 to 230-128 to produce a second sum in the analog voltage domain, as discussed further below.

In the example in FIG. 2, the first summer 250 includes a first capacitor array 252 including 2⁽ⁿ⁻¹⁾ capacitors 255-1 to 255-128, in which each of the capacitors 255-1 to 255-128 is coupled between the output 226-1 to 226-128 of a respective one of the multipliers 220-1 to 220-128 and a first summing node 262. The capacitors 255-1 to 255-128 may have equal capacitances (e.g., for uniformly weighted products), but are not limited to this example. In this example, the first summer 250 generates a voltage at the first summing node 262 approximately equal to the following:

$$voltage\_sum1 = [ sum 1 / {2}^{( n - 1 )} ] * Vdd \qquad ( 2 )$$

where sum1 is the first sum, Vdd is the supply voltage, and voltage_sum1 is the voltage at the first summing node 262 representing the first sum in the analog voltage domain. In this example, the voltage at the first summing node 262 has 2⁽ⁿ⁻¹⁾ possible voltage levels representing 2⁽ⁿ⁻¹⁾ possible values for the first sum.

In the example in FIG. 2, the second summer 256 includes a second capacitor array 258 including 2⁽ⁿ⁻¹⁾ capacitors 260-1 to 260-128, in which each of the capacitors 260-1 to 260-128 is coupled between the output 236-1 to 236-128 of a respective one of the multipliers 230-1 to 230-128 and a second summing node 264. The capacitors 260-1 to 260-128 may have equal capacitances (e.g., for uniformly weighted products), but are not limited to this example. In this example, the second summer 256 generates a voltage at the second summing node 264 approximately equal to the following:

$$voltage\_sum2 = [ sum 2 / {2}^{( n - 1 )} ] * Vdd \qquad ( 3 )$$

where sum2 is the second sum, Vdd is the supply voltage, and voltage_sum2 is the voltage at the second summing node 264 representing the second sum in the analog voltage domain. In this example, the voltage at the second summing node 264 has 2⁽ⁿ⁻¹⁾ possible voltage levels representing 2⁽ⁿ⁻¹⁾ possible values for the second sum.

The switching circuit 280 has a first terminal 282 coupled to the first summing node 262, a second terminal 284 coupled to the second summing node 264, and a third terminal 286. The switching circuit 280 may be implemented with multiple switches, as discussed further below. The ADC 270 has an input 272 coupled to the third terminal 286 of the switching circuit 280, and an output 274. The shift circuit 290 has an input 292 coupled to the output 274 of the ADC 270, and an output 294. As discussed further below, the shift circuit 290 is configured to multiply the digital signal from the ADC 270 by two (e.g., by shifting the digital signal from the ADC 270 to the left by one bit position). An exemplary implementation of the ADC 270 is discussed below.

During operation, after the first sum appears on the first summing node 262 and the second sum appears on the second summing node 264, the switching circuit 280 couples the first summing node 262 to the second summing node 264. This causes an average of the first sum and the second sum to appear at the third terminal 286. The average of the first sum and the second sum is equal to the sum of the 2ⁿ products (i.e., the sum of the first set of 2⁽ⁿ⁻¹⁾ products and the second set of 2⁽ⁿ⁻¹⁾ products) divided by two. Note that the average of the first sum and the second sum is represented in the analog voltage domain at the third terminal 286 as:

$$voltage\_average = [ voltage\_sum1 + voltage\_sum2 ] / 2 \qquad ( 4 )$$

where voltage_average is the voltage at the third terminal 286 representing the average of the first sum and the second sum in the analog voltage domain.

The ADC 270 converts the average of the first sum and the second sum into a digital signal indicating the average of the first sum and the second sum. The shift circuit 290 then multiplies the digital signal from the ADC 270 by two to generate the n-bit digital signal discussed above. Since the digital signal from the ADC 270 indicates the average of the first sum and the second sum (which is equal to the sum of the 2ⁿ products divided by two), multiplying the digital signal from the ADC 270 by two causes the n-bit digital signal to indicate the sum of the 2ⁿ products (i.e., the sum of the two 2⁽ⁿ⁻¹⁾ products).

In certain aspects, the multiply and accumulate circuit 210 generates the first set of 2⁽ⁿ⁻¹⁾ products and the first sum during a first cycle of a clock signal, and generates the second set of 2⁽ⁿ⁻¹⁾ products and the second sum during a second cycle of the clock signal. In these aspects, the first sum and the second sum are accumulated over two cycles of the clock signal, and the n-bit digital signal indicating the sum of the 2ⁿ products (i.e., the sum of the two 2⁽ⁿ⁻¹⁾ products) is generated every other cycle of the clock signal, which reduces power consumption. The first cycle and the second cycle are discussed further below according to certain aspects.

As discussed above, the exemplary multiply and accumulate circuit 210 is able to accurately convert the sum of the 2ⁿ products (i.e., the sum of the two 2⁽ⁿ⁻¹⁾ products) into the n-bit digital signal when the sum is even (i.e., the sum is a sum of an even number of ones). This is because, when the sum of the 2ⁿ products is even, the average of the first sum and the second sum is an integer, which can be accurately converted into a digital signal with a resolution of (n−1) bits. For example, if the first sum is 2 and the second sum is 4, then the sum of the 2ⁿ products is 6 and the average of the first sum and the second sum is (4+2)/2=3, which is an integer. In this example, the ADC 270 accurately converts the average into a digital signal of 0000011 at the output 274 of the ADC 270, which indicates the correct average of 3. The shift circuit 290 multiples the digital signal from the ADC 270 by two by shifting the digital signal to the left by one bit position. The shift produces a digital signal of 00000110, which indicates the current sum of 6.

The sum of the 2ⁿ products is even when the first sum and the second sum have the same parity (i.e., the first sum and the second sum are both even or the first sum and the second sum are both odd). Thus, the exemplary multiply and accumulate circuit 210 is able to accurately convert the sum of the 2ⁿ products into the n-bit digital signal when the first sum and the second sum have the same parity.

However, the exemplary multiply and accumulate circuit 210 is not able to accurately convert the sum of the 2ⁿ products in cases where the sum is odd. This is because, when the sum of the 2ⁿ products is odd, the average of the first sum and the second sum is a non-integer with a fractional part of 0.5, which cannot be accurately converted with a resolution of (n−1) bits. For example, if the first sum is 1 and the second sum is 2, then the sum of the 2ⁿ products is 3 and the average of the first sum and the second sum is (1+2)/2=1.5, which is a non-integer. In this example, the ADC 270 will incorrectly convert the average into 1 or 2, which will result in an incorrect sum of 2 or 4 at the output 294 of the shift circuit 290.

The sum of the 2ⁿ products is odd when the first sum and the second sum have different parities (i.e., the first sum is odd and the second sum is even, or the first sum is even and the second sum is odd). Thus, the exemplary multiply and accumulate circuit 210 is not able to accurately convert the sum of the 2ⁿ products into the n-bit digital signal when the first sum and the second sum have the different parities.

To address the above, aspects of the present disclosure provide the multiply and accumulate circuit 210 with odd exception handling capability that allows the multiply and accumulate circuit 210 to accurately convert the sum of the 2ⁿ products into the n-bit digital signal when the sum is odd (i.e., the first sum and the second sum have the different parities), as discussed further below.

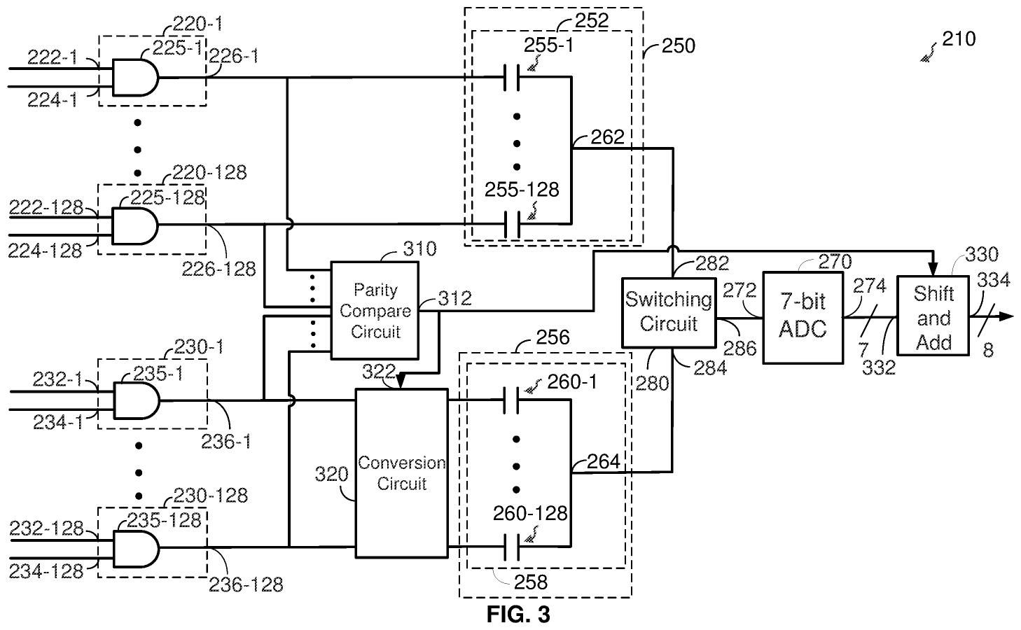

FIG. 3 shows an example of the multiply and accumulate circuit 210 with odd exception handling capability according to certain aspects of the present disclosure. In this example, the multiply and accumulate circuit 210 also includes a parity compare circuit 310 and a conversion circuit 320. The multiply and accumulate circuit 210 also includes a shift and add circuit 330 in place of the shift circuit 290 in FIG. 2. As discussed further below, the parity compare circuit 310, the conversion circuit 320, and the shift and add circuit 330 provide the multiply and accumulate circuit 210 with odd exception handling capability, which allows the multiply and accumulate circuit 210 to accurately convert the sum of the 2ⁿ products (i.e., the sum of the two 2⁽ⁿ⁻¹⁾ products) into the n-bit digital signal when the sum of the 2ⁿ products is odd (i.e., the first sum and the second sum have the different parities).

The parity compare circuit 310 is coupled to the outputs 226-1 to 226-128 of the multipliers 220-1 to 220-128 and the outputs 236-1 to 236-128 of the multipliers 230-1 to 230-128. The parity compare circuit 310 is configured to detect a parity of the number of ones in the first set of 2⁽ⁿ⁻¹⁾ products (i.e., number of ones in the first products), detect a parity of the number of ones in the second set of 2⁽ⁿ⁻¹⁾ products (i.e., number of ones in the second products), and output a parity compare signal at the output 312 indicating whether the number of ones in the first set of 2⁽ⁿ⁻¹⁾ products and the number of ones in the second set of 2⁽ⁿ⁻¹⁾ products have the same parity or different parties. For example, the parity compare circuit 310 may output a one if the number of ones in the first set of 22⁽ⁿ⁻¹⁾ products and the number of ones in the second set of 2⁽ⁿ⁻¹⁾ products have different parities, and output a zero if the number of ones in the first set of 2⁽ⁿ⁻¹⁾ products and the number of ones in the second set of 2⁽ⁿ⁻¹⁾ products have the same parity, or vice versa.

In certain aspects, the parity compare circuit 310 determines the number of ones in the first set of 2⁽ⁿ⁻¹⁾ products and the number of ones in the second set of 2⁽ⁿ⁻¹⁾ products have the same parity if the number of ones in the first set of 2⁽ⁿ⁻¹⁾ products is even and the number of ones in the second set of 2⁽ⁿ⁻¹⁾ products is even, or the number of ones in the first set of 2⁽ⁿ⁻¹⁾ products is odd and the number of ones in the second set of 2⁽ⁿ⁻¹⁾ products is odd. The parity compare circuit 310 determines the number of ones in the first set of 2⁽ⁿ⁻¹⁾ products and the number of ones in the second set of 2⁽ⁿ⁻¹⁾ products have the different parities if the number of ones in the first set of 2⁽ⁿ⁻¹⁾ products is even and the number of ones in the second set of 2⁽ⁿ⁻¹⁾ products is odd, or the number of ones in the first set of 2⁽ⁿ⁻¹⁾ products is odd and the number of ones in the second set of 2⁽ⁿ⁻¹⁾ products is even.

The parity compare signal indicates whether odd exception handling is needed. As discussed further below, odd exception handling is needed when the parity compare signal indicates the number of ones in the first set of 2⁽ⁿ⁻¹⁾ products and the number of ones in the second set of 2⁽ⁿ⁻¹⁾ products have different parities.

The conversion circuit 320 is coupled between the outputs 236-1 to 236-128 of the multipliers 230-1 to 230-128 and the second summer 256. The conversion circuit 320 also has an input 322 coupled to the output 312 of the parity compare circuit 310 to receive the parity compare signal from the parity compare circuit 310.

If the parity compare signal indicates the number of ones in the first set of 2⁽ⁿ⁻¹⁾ products and the number of ones in the second set of 2⁽ⁿ⁻¹⁾ products have the same parity, then the conversion circuit 320 passes the second set of 2⁽ⁿ⁻¹⁾ products at the outputs 236-1 to 236-128 of the multipliers 230-1 to 230-128 to the second summer 256 unchanged. In this case, the sum of the 2ⁿ products (i.e., sum of the two 2⁽ⁿ⁻¹⁾ products) is even and the odd exception handling is not needed.

If the parity compare signal indicates the number of ones in the first set of 2⁽ⁿ⁻¹⁾ products and the number of ones in the second set of 2⁽ⁿ⁻¹⁾ products have different parities, then the conversion circuit 320 changes the bit value of one of the products in the second set of 2⁽ⁿ⁻¹⁾ products (i.e., one of the second products) from one to zero (e.g., changes the voltage of the product from Vdd to zero volts) before passing the second set of 2⁽ⁿ⁻¹⁾ products to the second summer 256. The bit value change causes the first sum and the second sum to have the same parity, and thus, the sum of the 2ⁿ products to be even. This causes the average of the first sum and the second sum to be an integer, which allows the ADC 270 to accurately convert the average of the first sum and the second sum at the input 272 into a digital signal at the output 274.

The shift and add circuit 330 has an input 332 coupled to the output 274 of the ADC 270 and an output 334. In the example in FIG. 3, the shift and add circuit 330 is coupled to the output 312 of the parity compare circuit 310 to receive the parity compare signal.

If the parity compare signal indicates the number of ones in the first set of 2⁽ⁿ⁻¹⁾ products and the number of ones in the second set of 2⁽ⁿ⁻¹⁾ products have different parities, then the shift and add circuit 330 shifts the digital signal from the ADC 270 by one bit position to multiply the digital signal by two, and adds one to the shifted digital signal. In this case, the one is added to the shifted digital signal to undo the bit value change of one of the products in the set of 2⁽ⁿ⁻¹⁾ products from one to zero by the conversion circuit 320.

If the parity compare signal indicates the number of ones in the first set of 2⁽ⁿ⁻¹⁾ products and the number of ones in the second set of 2⁽ⁿ⁻¹⁾ products have the same parity, then the shift and add circuit 330 shifts the digital signal from the ADC 270 by one bit position to multiply the digital signal by two without adding one to the shifted digital signal.

The parity compare circuit 310, the conversion circuit 320, and the shift and add circuit 330 allow the exemplary multiply and accumulate circuit 210 to accurately convert the sum of the 2ⁿ products (i.e., sum of two 2⁽ⁿ⁻¹⁾ products) in cases where the sum is odd. For example, if the first sum is 1 and the second sum is 2, then the parity compare signal indicates the number of ones in the first set of 2⁽ⁿ⁻¹⁾ products and the number of ones in the second set of 2⁽ⁿ⁻¹⁾ products have different parities. In response, the conversion circuit 320 converts the bit value of one of the products in the second set of 2⁽ⁿ⁻¹⁾ products from one to zero, which changes the second sum from 2 to 1. This also changes the sum of the 2ⁿ products (i.e., sum of the two 2⁽ⁿ⁻¹⁾ products) from 3 to 2, which is even. After the change, the average of the first sum and the second sum is (1+1)/2=1, which is an integer. In this example, the ADC 270 correctly converts the average into a digital signal indicating 1. The shift and add circuit 330 doubles the digital signal and adds a one, resulting in a digital signal at the output 334 that indicates the correct sum of 3.

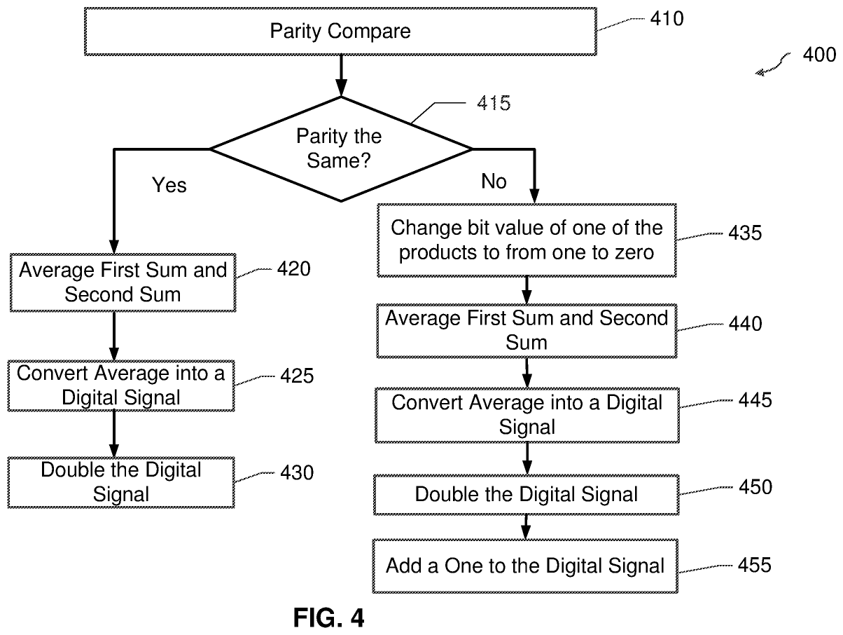

FIG. 4 shows an exemplary method 400 that may be performed by the multiply and accumulate circuit 210 shown in FIG. 3 according to certain aspects of the present disclosure. The method 400 includes odd exception handling for handing the case when the sum of the 2ⁿ products is odd.

At block 410, the parity compare circuit 310 compares the parity of the number of ones in the first set of 2⁽ⁿ⁻¹⁾ products with the parity of the number of ones in the second set of 2⁽ⁿ⁻¹⁾ products.

If the number of ones in the first set of 2⁽ⁿ⁻¹⁾ products and the number of ones in the second set of 2⁽ⁿ⁻¹⁾ products have the same parity at block 415 (which indicates that the sum of the 2ⁿ products is even), then the method proceeds to block 420.

At block 420, the first sum and the second sum are averaged in the analog voltage domain. For example, the switching circuit 280 may average the first sum and the second sum by coupling the first summing node 262 to the second summing node 264.

At block 425, the ADC 270 converts the average of the first sum and the second sum into a digital signal at the output 274 with a bit resolution of (n−1) bits.

At block 430, the digital signal from the ADC 270 is doubled (i.e., multiplied by two). For example, the shift and add circuit 330 may double the digital signal by shifting the digital signal to the left by one bit position. The digital signal after the doubling provides a digital representation of the sum of the 2ⁿ products (i.e., sum of two 2⁽ⁿ⁻¹⁾ products).

If the number of ones in the first set of 2⁽ⁿ⁻¹⁾ products and the number of ones in the second set of 2⁽ⁿ⁻¹⁾ products have the different parities at block 415 (which indicates that the sum of the 2ⁿ products is odd), then the method proceeds to block 435.

At block 435, the conversion circuit 320 converts the bit value of one of the products from one to zero. This change causes the first sum and the second sum to have the same parity, and thus, the sum of the 2ⁿ products to be even.

At block 440, the first sum and the second sum are averaged in the analog voltage domain. For example, the switching circuit 280 may average the first sum and the second sum by coupling the first summing node 262 to the second summing node 264.

At block 445, the ADC 270 converts the average of the first sum and the second sum into a digital signal at the output 274 with a bit resolution of (n−1) bits.

At block 450, the digital signal from the ADC 270 is doubled (i.e., multiplied by two). For example, the shift and add circuit 330 may double the digital signal by shifting the digital signal to the left by one bit position.

At block 455, the shift and add circuit 330 adds a one to the digital signal to undo the bit value change in block 435. In some implementations, the shift and add circuit 330 may perform the shifting and the addition of one concurrently. The digital signal after the doubling and the addition of one provides a digital representation of the sum of the 2ⁿ products (i.e., sum of two 2⁽ⁿ⁻¹⁾ products).

In the example in FIG. 3, each of the multipliers 220-1 to 220-128 is implemented with a respective AND gate 225-1 to 225-128, and each of the multipliers 230-1 to 230-128 is implemented with a respective AND gate 235-1 to 235-128. However, it is to be appreciated that the present disclosure is not limited to this example. For example, each of the multipliers 220-1 to 220-128 and each of the multipliers 230-1 to 230-128 may be implemented with a NAND gate, a NOR gate, one or more inverters, or any combination thereof.

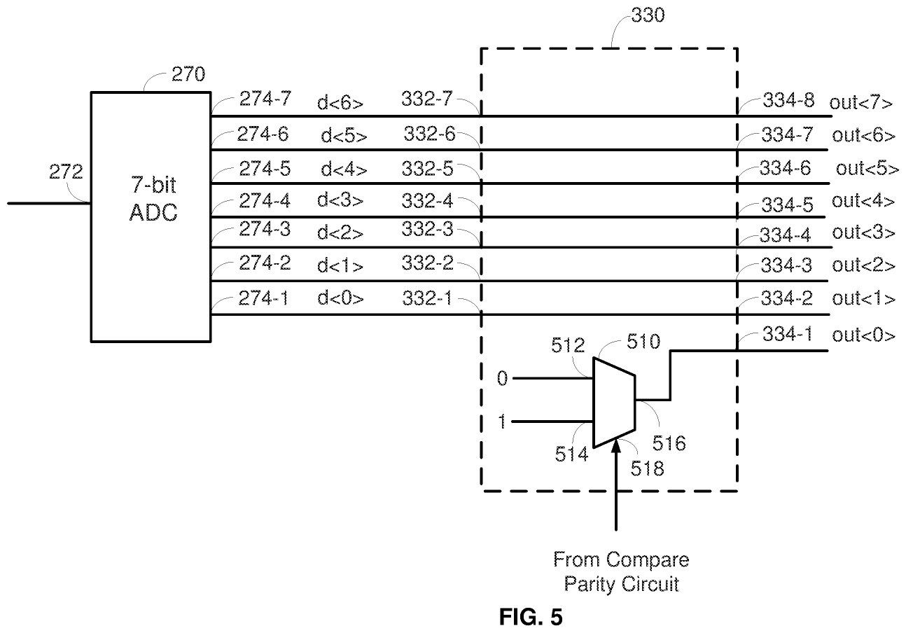

FIG. 5 shows an exemplary implementation of the shift and add circuit 330 according to certain aspects of the present disclosure. In this example, the output 274 of the ADC 270 includes (n−1) parallel outputs 274-1 to 274-7 for outputting the digital signal of the ADC 270. The digital signal includes (n−1) bits, which are labeled d<0> to d<6> in FIG. 5. The bit d<0> is the least significant bit (LSB) of the digital signal and the bit d<6> is the most significant bit (MSB) of the digital signal. Each of the bits d<0> to d<6> is output on a respective one of the outputs 274-1 to 274-7 of the ADC 270.

In this example, the input 332 of the shift and add circuit 330 includes (n−1) parallel inputs 332-1 to 332-7 coupled to the (n−1) outputs 274-1 to 274-7 of the ADC 270, respectively. The output 334 of the shift and add circuit 330 includes n parallel outputs 334-1 to 334-8. The digital signal that is output by the shift and add circuit 330 includes n bit, which are labeled out<0> to out<7> in FIG. 5. The bit out<0> is the LSB and the bit out<7> is the MSB. Each of the bits out<0> to out<7> is output on a respective one of the n outputs 334-1 to 334-8.

In this example, the shift and add circuit 330 shifts the digital signal from the ADC 270 by one position by mapping the bits d<0> to d<6> of the digital signal to higher order bits out<1> to out<7>, respectively, at the outputs 334-2 to 334-8 of the shift and add circuit 330. For example, the LSB bit d<0> in the digital signal is mapped to the bit out<1> at the output 334-2, which is one order higher than the LSB bit. In other words, each of the bits d<0> to d<6> is mapped to a respective one of the bits out<1> to out<7> that is one order higher. In the example in FIG. 5, the inputs 332-1 to 332-7 are coupled to the outputs 334-2 to 334-8, respectively.

In this example, the shift and add circuit 330 includes a multiplexer 510 having a first input 512, a second input 514, a select input 518, and an output 516. The first input 512 is held at the bit value of zero (e.g., ground) and the second input 514 is held at the bit value of one (e.g., a voltage approximately equal to Vdd). The output 516 of the multiplexer 510 is coupled to the output 334-1 of the shift and add circuit 330, which corresponds to the LSB out<0>. Thus, the output 516 of the multiplexer 510 provides the LSB out<0> of the output digital signal out<0> to <7>. The select input 518 receives the parity compare signal from the parity compare circuit 310 (shown in FIG. 3).

The multiplexer 510 is configured to select one of the inputs 512 and 514 based on the parity compare signal. If the parity compare signal indicates the number of ones in the first set of 2⁽ⁿ⁻¹⁾ products and the number of ones in the second set of 2⁽ⁿ⁻¹⁾ products have the same parity, then the multiplexer 510 selects the first input 512 and outputs the bit value of zero for the LSB out<0>. In this case, the output digital signal out<0> to out<7> is double the digital signal d<0> to d<6>. Thus, in this case, the shift and add circuit 330 multiplies the digital signal from the ADC 270 by two.

If the parity compare signal indicates the number of ones in the first set of 2⁽ⁿ⁻¹⁾ products and the number of ones in the second set of 2⁽ⁿ⁻¹⁾ products have different parities, then the multiplexer 510 selects the second input 514 and outputs the bit value of one for the LSB out<0>. In this case, the output digital signal out<0> to out<7> is double the digital signal d<0> to d<6> plus one. Thus, in this case, the shift and add circuit 330 multiplies the digital signal from the ADC 270 by two and adds one to the digital signal.

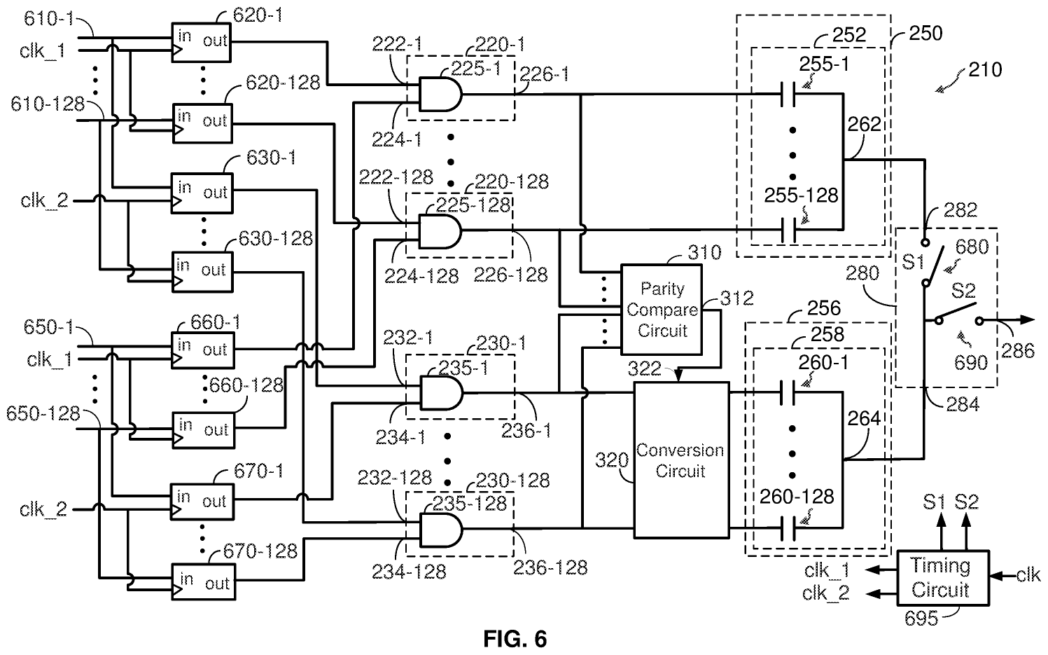

FIG. 6 shows an exemplary implementation of the multiply and accumulate circuit 210 in which the first set of 2⁽ⁿ⁻¹⁾ products and the first sum are generated during a first cycle of the clock signal clk, and the second set of 2⁽ⁿ⁻¹⁾ products and the second sum are generated during a second cycle of the clock signal clk. In this example, the first sum and the second sum are accumulated over two cycles of the clock signal clk, and the n-bit digital signal indicating the sum of the 2ⁿ product (i.e., sum of two 2⁽ⁿ⁻¹⁾ products) is generated every other cycle of the clock signal clk, which reduces power consumption.

In the example shown in FIG. 6, the multiply and accumulate circuit 210 includes a first set of latches 620-1 to 620-128, a second set of latches 630-1 to 630-128, a third set of latches 660-1 to 660-128, a fourth set of latches 670-1 to 670-128, and a timing circuit 695. Also, in this example, the switching circuit 280 includes a first switch 680 coupled between the first terminal 282 and the second terminal 284, and a second switch 690 coupled between the second terminal 284 and the third terminal 286. However, it is to be appreciated that the switching circuit 280 is not limited to this example.

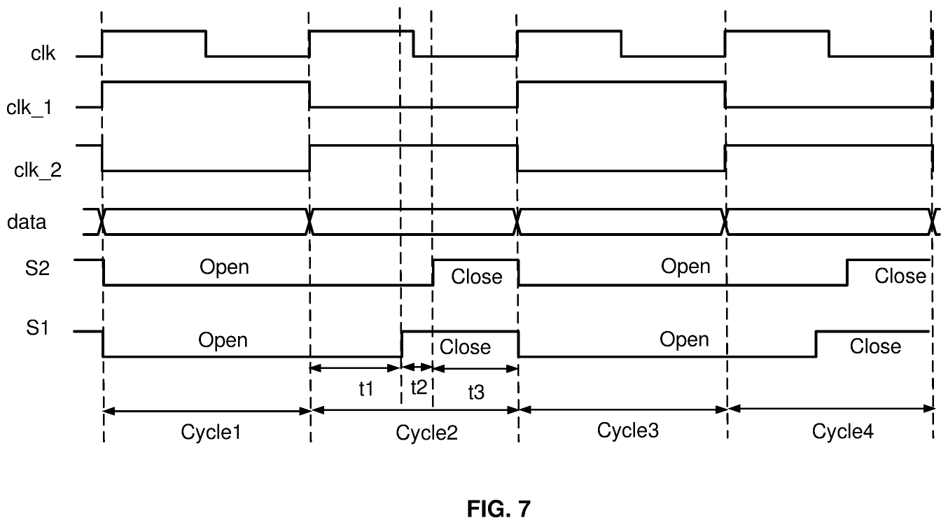

The timing circuit 695 is configured to receive the clock signal clk, and generate a first cycle clock signal clk_1 and a second cycle clock signal clk_2 based on the clock signal clk. FIG. 7 shows an exemplary timing diagram of the clock signal clk, the first cycle clock signal clk_1, and the second cycle clock signal clk_2. In this example, each of the first cycle clock signal clk_1 and the second cycle clock signal clk_2 has half the frequency of the clock signal clk, in which the first cycle clock signal clk_1 and the second cycle clock signal clk_2 are 180 degrees out of phase.

In this example, the first set of bits and the second set of bits are received via the inputs 610-1 to 610-128 and the inputs 650-1 to 650-128, respectively, during the first cycle of the clock signal. The third set of bits and the fourth set of bits are received via the inputs 610-1 to 610-128 and the inputs 650-1 to 650-128, respectively, during the second cycle of the clock signal.

Each of the latches 620-1 to 620-128 has a respective input (labeled “in”) coupled to a respective one the inputs 610-1 to 610-128, and a respective output (labeled “out”) coupled to the first input 222-1 to 220-128 of a respective one of the multipliers 220-1 to 220-128. The latches 620-1 to 620-128 are configured to receive the first cycle clock signal clk_1 and latch the first set of bits at the respective inputs on a rising edge of the first cycle clock signal clk_1.

Each of the latches 630-1 to 630-128 has a respective input (labeled “in”) coupled to a respective one the inputs 610-1 to 610-128, and a respective output (labeled “out”) coupled to the first input 232-1 to 232-128 of a respective one of the multipliers 230-1 to 230-128. The latches 630-1 to 630-128 are configured to receive the second cycle clock signal clk_2 and latch the third set of bits at the respective inputs on a rising edge of the second cycle clock signal clk_2.

Each of the latches 660-1 to 660-128 has a respective input (labeled “in”) coupled to a respective one the inputs 650-1 to 650-128, and a respective output (labeled “out”) coupled to the second input 224-1 to 224-128 of a respective one of the multipliers 220-1 to 220-128. The latches 660-1 to 660-128 are configured to receive the first cycle clock signal clk_1 and latch the second set of bits at the respective inputs on a rising edge of the first cycle clock signal clk_1.

Each of the latches 670-1 to 670-128 has a respective input (labeled “in”) coupled to a respective one the inputs 650-1 to 650-128, and a respective output (labeled “out”) coupled to the second input 234-1 to 234-128 of a respective one of the multipliers 230-1 to 230-128. The latches 670-1 to 670-128 are configured to receive the second cycle clock signal clk_2 and latch the fourth set of bits at the respective inputs on a rising edge of the second cycle clock signal clk_2.

Exemplary operations of the multiply and accumulate circuit 210 shown in FIG. 6 will now be discussed according to certain aspects.

During the first cycle of the clock signal clk (labeled “Cycle1” in FIG. 7), the latches 620-1 to 620-128 latch the first set of bits received via the inputs 610-1 to 610-128 on the rising edge of the first cycle clock signal clk_1, and the latches 660-1 to 660-128 latch the second set of bits received via the inputs 650-1 to 650-128 on the rising edge of the first cycle clock signal clk_1. The latches 620-1 to 620-128 output the latched first set of bits to the first inputs 222-1 to 222-128 of the multipliers 220-1 to 220-128, and the latches 660-1 to 660-128 outputs the latched second set of bits to the second inputs 224-1 to 224-128 to the multipliers 220-1 to 220-128. The multipliers 220-1 to 220-128 perform bit-wise multiplications on the first set of bits and the second set of bits to generate the first set of 2⁽ⁿ⁻¹⁾ products, and output the first set of 2⁽ⁿ⁻¹⁾ products to the first summer 250 via the respective outputs 226-1 to 226-128. The first summer 250 sums the first set of 2⁽ⁿ⁻¹⁾ products to generate the first sum in the analog voltage domain at the first summing node 262.

During the second cycle of the clock signal clk (labeled “Cycle2” in FIG. 7), the latches 630-1 to 630-128 latch the third set of bits received via the inputs 610-1 to 610-128 on the rising edge of the second cycle clock signal clk_2, and the latches 670-1 to 670-128 latch the fourth set of bits received via the inputs 650-1 to 650-128 on the rising edge of the second cycle clock signal clk_2. The latches 630-1 to 630-128 output the latched third set of bits to the first inputs 232-1 to 232-128 of the multipliers 230-1 to 230-128, and the latches 670-1 to 670-128 outputs the latched fourth set of bits to the second inputs 234-1 to 234-128 to the multipliers 230-1 to 230-128. The multipliers 230-1 to 230-128 perform bit-wise multiplications on the third set of bits and the fourth set of bits to generate the second set of 2⁽ⁿ⁻¹⁾ products, and outputs the second set of 2⁽ⁿ⁻¹⁾ products via the respective outputs 236-1 to 236-128. If the parity compare circuit 310 indicates the number of ones in the first set of 2⁽ⁿ⁻¹⁾ products and the number of ones in the second set of 2⁽ⁿ⁻¹⁾ products have different parities, then the conversion circuit 320 converts the bit value of one of the products in the second set of 2⁽ⁿ⁻¹⁾ products from one to zero. The second summer 256 sums the second set of 2⁽ⁿ⁻¹⁾ products to generate the second sum in the analog voltage domain at the second summing node 264. Thus, in this example, the first sum is generated during the first cycle (labeled “Cycle1”) and the second sum is generated during the second cycle (labeled “Cycle2).

FIG. 7 shows exemplary switch control signals for controlling the on/off states of the first switch 680 (labeled “S1”) and the second switch 690 (labeled “S2”). The switch control signals may be generated by the timing circuit 695 based on the clock signal clk. During the first cycle (labeled “Cycle1”), the first switch 680 and the second switch 690 are both turned off (i.e., open).

During the second cycle (labeled “Cycle2”), the first switch 680 and the second switch 690 are both initially turned off (i.e., open) during a first portion (labeled “t1”) of the second cycle. During the first portion of the second cycle, the second summer 256 generates the second sum on the second summing node 264 in the analog voltage domain, as discussed above. After the first portion of the second cycle has elapsed, the first switch 680 is turned on (i.e., closed) during a second portion (labeled “t2”) of the second cycle. This causes the first switch 680 to couple the first summing node 262 to the second summing node 264, which produces the average of the first sum and the second sum in the analog voltage domain. During a third portion (labeled “t3”) of the second cycle, the second switch 690 is turned on (i.e., closed). This causes the second switch 690 to couple the average of the first sum and the second sum to the input 272 of the ADC 270 (shown in FIG. 3). The ADC 270 may sample the average of the first sum and the second sum at the input 272 during the third portion of the second cycle.

The multiply and accumulate circuit 210 may repeat the above operations over a third cycle (labeled “Cycle3”) and a fourth cycle (labeled “Cycle4”) of the clock signal clk to multiply and accumulate new sets of bits. The multiply and accumulate circuit 210 may include reset circuitry (not shown) for resetting the capacitors 255-1 to 255-128 and 260-1 to 260-128 (e.g., discharging the capacitors 255-1 to 255-128 and 260-1 to 260-128) for the third cycle and the fourth cycle.

During the third cycle, the ADC 270 may convert the average of the first sum and the second sum that was sampled during the second cycle into a digital signal at the output 274 of the ADC 270. The shift and add circuit 330 may then convert the digital signal from the ADC 270 into the final n-bit digital signal at the output 334, as discussed above. Note that, during the first cycle (labeled “Cycle1”), the ADC 270 may convert the average of the first sum and the second sum that was sampled during a previous cycle (i.e., a cycle preceding the first cycle) into a digital signal.

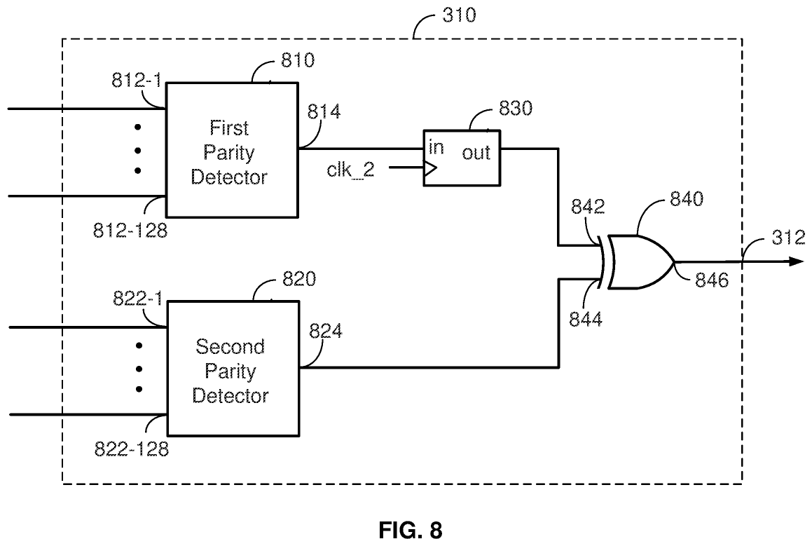

FIG. 8 shows an exemplary implementation of the parity compare circuit 310 according to certain aspects. In this example, the parity compare circuit 310 includes a first parity detector 810, a second parity detector 820, an XOR gate 840 (i.e., exclusive-OR gate), and a latch 830 (e.g., flop). A parity detector may also be referred to as a parity checker or another term.

In this example, the first parity detector 810 has inputs 812-1 to 812-128 coupled to respective outputs 226-1 to 226-128 of the multipliers 220-1 to 220-128, and an output 814. The first parity detector 810 is configured to detect the parity of the number of ones in the first set of 2⁽ⁿ⁻¹⁾ products and output a signal at the output 814 indicating the detected parity of the number of ones in the first set of 2⁽ⁿ⁻¹⁾ products. For example, the first parity detector 810 may output a one when the number of ones in the first set of 2⁽ⁿ⁻¹⁾ products is odd and output a zero when the number of ones in the first set of 2⁽ⁿ⁻¹⁾ products is even, or vice versa.

The second parity detector 820 has inputs 822-1 to 822-128 coupled to respective outputs 236-1 to 236-128 of the multipliers 230-1 to 230-128, and an output 824. The second parity detector 820 is configured to detect the parity of the number of ones in the second set of 2⁽ⁿ⁻¹⁾ products and output a signal at the output 824 indicating the detected parity of the number of ones in the second set of 2⁽ⁿ⁻¹⁾ products. For example, the second parity detector 820 may output a one when the number of ones in the second set of 2⁽ⁿ⁻¹⁾ products is odd and output a zero when the number of ones in the second set of 2⁽ⁿ⁻¹⁾ products is even, or vice versa.

The latch 830 has an input (labeled “in”) coupled to the output 814 of the first parity detector, and an output (labeled “out”). The latch 830 is configured to receive the second cycle clock signal clk_2, latch the signal from the first parity detector 810 on a rising edge of the second cycle clock signal clk_2, and output the latched signal at the output of the latch 830.

The XOR gate 840 has an first input 842 coupled to the output of the latch 830, a second input 844 coupled to the second parity detector 820, and an output 846 coupled to the output 312 of the parity compare circuit 310. In this example, the first parity detector 810 and the second parity detector 820 output the same logic value (i.e., one or zero) when the number of ones in the first set of 2⁽ⁿ⁻¹⁾ products and the number of ones in the second set of 2⁽ⁿ⁻¹⁾ products have the same parity. In this case, the XOR gate 840 outputs a zero at the output 312. The first parity detector 810 and the second parity detector 820 output different logic values when the number of ones in the first set of 2⁽ⁿ⁻¹⁾ products and the number of ones in the second set of 2⁽ⁿ⁻¹⁾ products have different parities. In this case, the XOR gate 840 outputs a one at the output 312. Thus, in this example, the XOR gate 840 outputs a zero when the number of ones in the first set of 2⁽ⁿ⁻¹⁾ products and the number of ones in the second set of 2⁽ⁿ⁻¹⁾ products have the same parity, and outputs a one when the number of ones in the first set of 2⁽ⁿ⁻¹⁾ products and the number of ones in the second set of 2⁽ⁿ⁻¹⁾ products have different parities. However, it is to be appreciated that the present disclosure is not limited to this example.

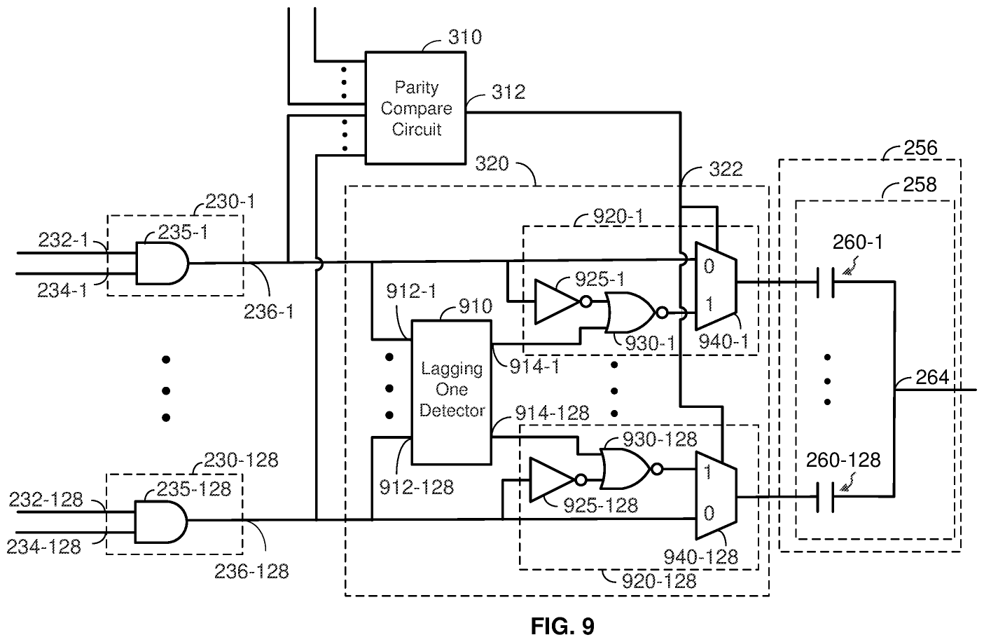

FIG. 9 shows an exemplary implementation of the conversion circuit 320 according to certain aspects. In this example, the conversion circuit 320 includes a lagging one detector 910, and a set of select circuits 920-1 to 920-128. The lagging one detector 910 has inputs 912-1 to 912-128 and outputs 914-1 to 914-128, in which each of the inputs 912-1 to 912-128 is coupled to the output 236-1 to 236-128 of a respective one of the multipliers 230-1 to 230-128. Each of the select circuits 920-1 to 920-128 is coupled to the output 312 of the parity compare circuit 310, the output 236-1 to 236-128 of a respective one of the multipliers 230-1 to 230-128, a respective one of the outputs 914-1 to 914-128 of the lagging one detector 910, and a respective one of the capacitors 260-1 to 260-128 of the second summer 256.

When the parity compare signal indicates the number of ones in the first set of 2⁽ⁿ⁻¹⁾ products and the number of ones in the second set of 2⁽ⁿ⁻¹⁾ products have the same parity, each of the select circuits 920-1 to 920-128 is configured to couple the output 236-1 to 236-128 of the respective one of the multipliers 230-1 to 230-128 to the respective one of the capacitors 260-1 to 260-128 of the second summer 256. In this case, the select circuits 920-1 to 920-128 pass the second set of 2⁽ⁿ⁻¹⁾ products to the capacitors 260-1 to 260-128 of the second summer 256 unchanged.

When the parity compare signal indicates the number of ones in the first set of 2⁽ⁿ⁻¹⁾ products and the number of ones in the second set of 2⁽ⁿ⁻¹⁾ products have different parities, the select circuits 920-1 to 920-128 change the bit value of one of the products in the second set of 2⁽ⁿ⁻¹⁾ products from one to zero based on the outputs of the lagging one detector 910 and pass the second set of 2⁽ⁿ⁻¹⁾ products after the bit value change to the capacitors 260-1 to 260-128 of the second summer 256, as discussed further below.

The lagging one detector 910 is configured to detect one of the products in the second set of 2⁽ⁿ⁻¹⁾ products having a bit value of one, and output a one at the respective one of the outputs 914-1 to 914-128. This causes the respective one of the select circuits 920-1 to 920-128 to change the bit value of the detected product from one to zero. The lagging one detector 910 outputs a zero at each of the remaining outputs 914-1 to 914-128, which causes each of the respective select circuits 920-1 to 920-128 to pass the respective product unchanged.

In the example in FIG. 9, each of the select circuits 920-1 to 920-128 includes a respective multiplexer 940-1 to 940-128, a respective NOR gate 930-1 to 930-1, and a respective inverter 925-1 to 925-128. In each of the select circuits 920-1 to 920-128, the respective multiplexer 940-1 to 940-128 has a first input (labeled “0”) coupled to the output 236-1 to 236-128 of the respective one of the multipliers 230-1 to 230-128, a second input (labeled “1”), a select input coupled to the output 312 of the parity compare circuit 310, and an output coupled to the respective capacitor 260-1 to 260-128 of the second summer 256. Also, in each of the select circuits 920-1 to 920-128, the respective NOR gate has a first input coupled to the output 236-1 to 236-128 of the respective one of the multipliers 230-1 to 230-128 through the respective inverter 925-1 to 925-128, a second input coupled the respective output 914-1 to 914-128 of the lagging one detector 910, and an output coupled to the second input of the respective multiplexer 940-1 to 940-128.

Each of the multiplexers 940-1 to 940-128 is configured to select the respective first input (labeled “0”) when the parity compare signal from the parity compare circuit 310 indicates the number of ones in the first set of 2⁽ⁿ⁻¹⁾ products and the number of ones in the second set of 2⁽ⁿ⁻¹⁾ products have the same parity. This causes the multiplexers 940-1 to 940-128 to pass the second set of 2⁽ⁿ⁻¹⁾ products to the second summer 256 unchanged.

Each of the multiplexers 940-1 to 940-128 is configured to select the respective second input (labeled “1”) when the parity compare signal from the parity compare circuit 310 indicates the number of ones in the first set of 2⁽ⁿ⁻¹⁾ products and the number of ones in the second set of 2⁽ⁿ⁻¹⁾ products have different parities. In this case, the NOR gate 930-1 to 930-128 coupled to the output 914-1 to 914-128 of the lagging one detector 910 outputting a one outputs a zero to the second input (labeled “1”) of the respective multiplexer 940-1 to 940-128. This causes the respective multiplexer 940-1 to 940-128 to output a zero, which effectively changes the bit value of the corresponding product from one to zero. The remaining select circuits 920-1 to 920-128 pass the remaining products of the second set of 2⁽ⁿ⁻¹⁾ products to the second summer 256 unchanged.

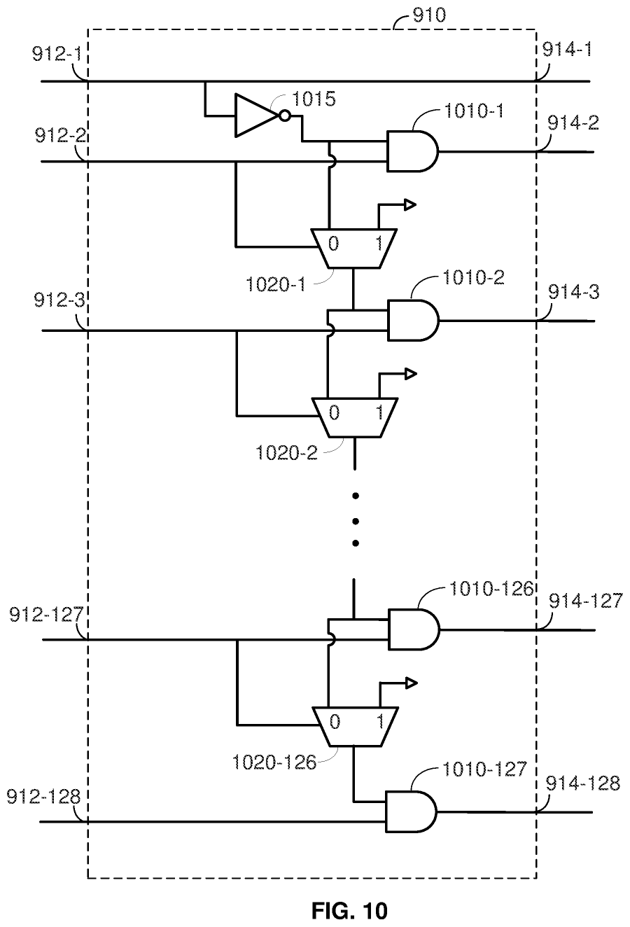

FIG. 10 shows an exemplary implementation of the lagging one detector 910 according to certain aspects. In this example, the lagging one detector 910 includes AND gates 1010-1 to 1010-127, multiplexers 1020-1 to 1020-126, and an inverter 1015 as arranged in FIG. 10. However, it is to be appreciated that the lagging one detector 910 is not limited to the exemplary implementation shown in FIG. 10, and that other implementations are possible.

In this example, the lagging one detector 910 is configured to detect one of the products in the second set of 2⁽ⁿ⁻¹⁾ products having a bit value of one, output a one at the respective one of the outputs 914-1 to 914-128, and output a zero at each of the remaining outputs 914-1 to 914-128. For example, if the first product received at the input 912-1 is a one, then the lagging one detector 910 outputs a one at the corresponding output 914-1 and outputs a zero at each of the remaining outputs 914-2 to 914-128. If the first product received at the input 912-1 is zero and the second product received at the input 912-2 is one, then the lagging one detector 910 outputs a one at the corresponding output 914-2 and outputs a zero at each of the remaining outputs 914-1 and 914-3 to 914-128. If the first product received at input 912-1 is zero, the second product received at the input 912-2 is zero, and the third product received at the input 912-3 is one, then the lagging one detector 910 outputs a one at the corresponding output 914-3 and outputs a zero at each of the remaining outputs 914-1, 914-2, and 914-4 to 914-128, and so forth.

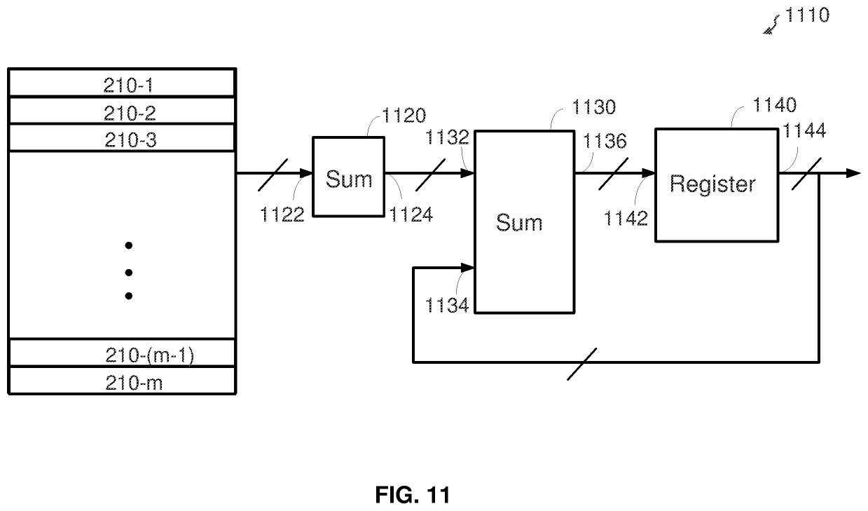

FIG. 11 shows an example of a multiply and accumulate system 1110 according to certain aspects. The multiply and accumulate system 1110 includes multiple multiply and accumulate circuits 210-1 to 210-m where each of the multiply and accumulate circuits 210-1 to 210-m is a respective instance (i.e., copy) of the multiply and accumulate circuit 210. In one example, the multiply and accumulate system 1110 is configured to receive sets of 8-bit values and perform MAC operations on the sets of 8-bit values. In this example, the multiply and accumulate system 1110 may include 64 multiply and accumulate circuits 210-1 to 210-m where each of the multiply and accumulate circuits 210-1 to 210-n computes a respective partial product. Since each of the multiply and accumulate circuits 210-1 to 210-n performs bit-wise multiplications in this example, 64 multiply and accumulate circuits 210-1 to 210-m may be used to perform 64 bit-wise multiplications for each multiplication of two 8-bit values.

In the example in FIG. 11, the multiply and accumulate system 1110 includes a first sum circuit 1120, a second sum circuit 1130, and a register 1140. The first sum circuit 1120 has an input 1122 coupled to the outputs of the multiply and accumulate circuits 210-1 to 210-m, and an output 1124. The first sum circuit 1120 is configured to receive the sums from the multiply and accumulate circuits 210-1 to 210-m (e.g., during every other cycle of the clock signal clk), sum the sums from the multiply and accumulate circuits 210-1 to 210-m to obtain a total sum, and output the total sum at the output 1124.

The second sum circuit 1130 has a first input 1132 coupled to the output 1124 of the first sum circuit 1120, a second input 1134, and an output 1136. The register 1140 has an input 1142 coupled to the output 1136 of the second sum circuit 1130, and an output 1144 coupled to the second input 1134 of the second sum circuit 1130. The output 1144 of the register 1140 provides the output of the multiply and accumulate system 1110.

In this example, the second sum circuit 1130 is configured to sum the sum from the output 1124 of the first sum circuit 1120 with the output of the register 1140, and output the resulting sum to the register 1140. The register 1140 stores the sum output from the second sum circuit 1130 and outputs the sum from the second sum circuit 1130 at the output 1144, which is fed back to second input 1134 of the second sum circuit 1130. As a result, the second sum circuit 1130 and the register 1140 form an accumulator that accumulates the sums output from the output 1124 of the first sum circuit 1120. In this regard, the register 1140 may also be referred to as an accumulation register since the register 1140 stores the accumulation of the sums from the first sum circuit 1120.

It is to be appreciated that the multiply and accumulate circuit 210 is not limited to the exemplary multiply and accumulate system 1110 shown in FIG. 11, and that one or more instances of the multiply and accumulate circuit 210 may be used in other types of systems (e.g., for performing MAC operations).

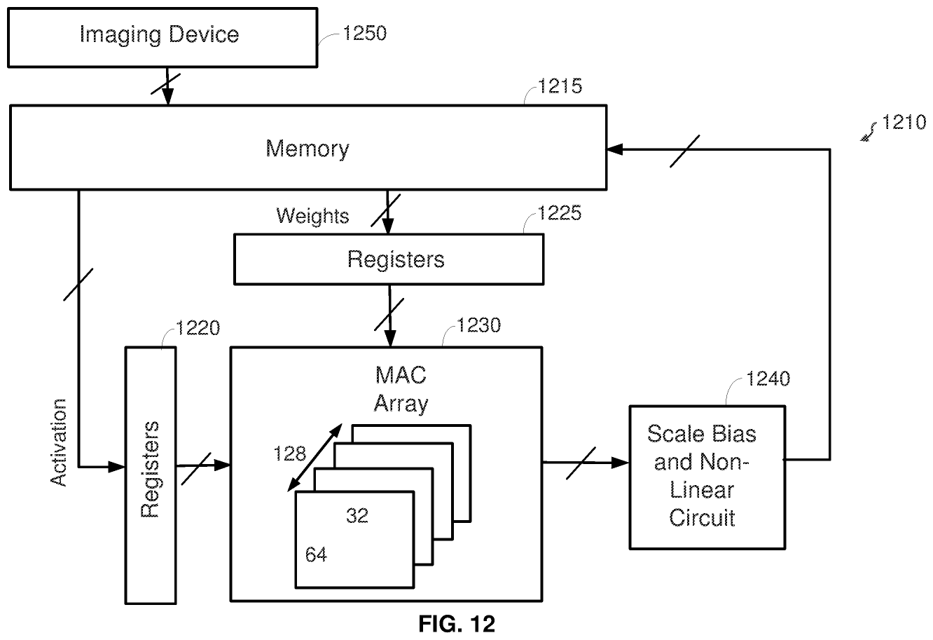

FIG. 12 shows an example of a machine learning accelerator 1210 (also referred to as an AI accelerator) according to certain aspects of the present disclosure. The machine learning accelerator 1210 may be used, for example, for performing computer vision inferencing and/or another type of inferencing. In this example, the machine learning accelerator 1210 includes a multiply and accumulate (MAC) array 1230, a memory 1215, first registers 1220, second registers 1225, and a scale bias and non-linear circuit 1240.

The memory 1215 may be used to store weights, activation values, and the results of processing by the machine learning accelerator 1210 (e.g., accumulations of products of weights and activation values). The first registers 1220 are coupled between the memory 1215 and the MAC array 1230, and the second registers 1225 are coupled between the memory 1215 and the MAC array 1230. The first registers 1220 are configured to receive activation values from the memory 1215 and input the activation values to the MAC array 1230, and the second registers 1225 are configured to receive weights from the memory 1215 and input the weights to the MAC array 1230.

The MAC array 1230 may include an array (e.g., 32×64 array) of multiple instances of the multiply and accumulate system 1110 illustrated in FIG. 11 for performing matrix multiplications on the weights and activation values. Since the multiply and accumulate system 1110 includes multiple instances of the multiply and accumulate circuit 210, the MAC array 1230 includes multiple instances of the multiply and accumulate circuit 210. In this example, the first set of bits and the third set of bits discussed above may each include respective activation bits from the activation values and the second set of bits and the fourth set of bits discussed above may each include respective weight bits from the weights.

The scale bias and non-linear circuit 1240 is coupled between the MAC array 1230 and the memory 1215. The scale bias and non-linear circuit 1240 may be configured to add a constant to the product of activation values and weights to offset the corresponding result by a minimum threshold. This helps ensure that the result can be output to the next AI model layer for cases where values below the threshold do not produce an output to the next AI model layer. Scaling may be needed in certain aspects to fit the data within a specific scale for improving the accuracy of results. The scale bias and non-linear circuit 1240 may also be configured to perform non-linear functions to enable a neural network to learn more complex relationships between the inputs and outputs and improve the accuracy and effectiveness of the neural network.

The machine learning accelerator 1210 may be used for computer vision inferencing in some implementations. For example, the memory 1215 may be coupled to an imaging device 1250 configured to capture an image for processing by the machine learning accelerator 1210. In this example, the memory 1215 stores the image, which may include a set of image values (e.g., pixel values). The memory 1215 outputs the image values to the first registers 1220, which inputs the image values to the MAC array 1230. In this example, the image values provide the activation values discussed above.

In this example, the weights discussed above may be the weights of a filter stored in the memory 1215. The memory 1215 outputs the weights of the filter to the second registers 1225, which inputs the weights to the MAC array 1230. The MAC array 1230 performs matrix multiplication on the image values and the weights of the filter to perform image inferencing. The image inferencing may be used may be, for example, to categorize one or more objects in the image. It is to be appreciated that the machine learning accelerator 1210 is not limited to image inferencing and may be used for other types of inferencing.

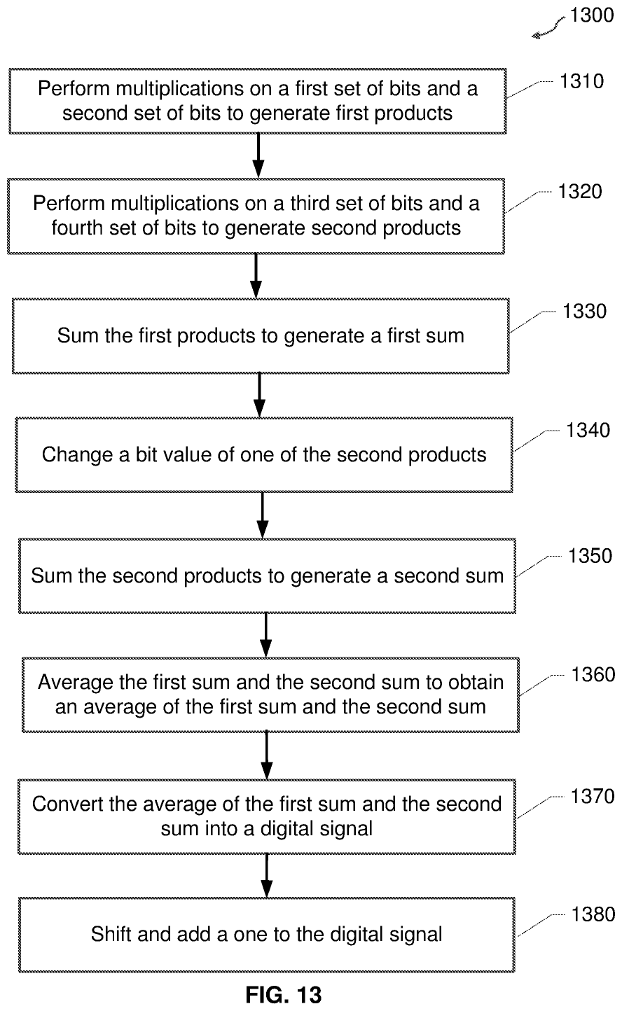

FIG. 13 shows an exemplary method 1300 for multiplication and accumulation according to certain aspects of the present disclosure.

At block 1310, multiplications are performed on a first set of bits and a second set of bits to generate first products. For example, the multiplications on the first set of bits and the second set of bits may be performed by the multipliers 220-1 to 220-128. In certain aspects, the multiplications may be bit-wise multiplications and the products may be one-bit products. The first products may correspond to the first set of 2⁽ⁿ⁻¹⁾ products.

At block 1320, multiplications are performed on a third set of bits and a fourth set of bits to generate second products. For example, the multiplications on the third set of bits and the fourth set of bits may be performed by the multipliers 230-1 to 230-128. In certain aspects, the multiplications may be bit-wise multiplications and the products may be one-bit products. The second products may correspond to the second set of 2⁽ⁿ⁻¹⁾ products.

At block 1330, the first products are summed to generate a first sum. For example, the first products may be summed by the first summer 250.

At block 1340, a bit value of one of the second products is changed. For example, the bit value may be changed by the conversion circuit 320. The bit value change may be from one to zero. The one of the second products may correspond to one of the products in the second set of 2⁽ⁿ⁻¹⁾ products.

At block 1350, the second products are summed to generate a second sum. For example, the second products may be summed by the second summer 256.

At block 1360, the first sum and the second sum are averaged to obtain an average of the first sum and the second sum. For example, the first sum and the second sum may be averaged by the switching circuit 280.

At block 1370, the average of the first sum and the second sum is converted into a digital signal. For example, the average of the first sum and the second sum may be converted into the digital signal by the ADC 270.

At block 1380, the digital signal is shifted and a one is added to the digital signal. For example, the shift and add circuit 330 may shift and add the one to the digital signal.

In certain aspects, the method 1300 further includes determining a number of ones in the first products and a number of ones in the second products have different parities. In these aspects, changing the bit value of the one of the second products includes changing the bit value of the one of the second products after a determination the number of ones in the first products and the number of ones in the second products have the different parities. The determination may be made by the parity compare circuit 310.

In certain aspects, shifting and adding the one to the digital signal includes shifting the digital by one bit position to multiply the digital signal by two, and outputting the one for a least significant bit (LSB) of the shifted digital signal.

In certain aspects, averaging the first sum and the second sum includes coupling the first summer 250 to the second summer 256 to obtain the average of the first sum and the second sum. For example, the first summer 250 may be coupled to the second summer 256 by the switching circuit 280.

Implementation examples are described in the following numbered clauses:
1. A system comprising:
   first multipliers configured to perform multiplications on a first set of bits and a second set of bits to generate first products;
   second multipliers configured to perform multiplications on a third set of bits and a fourth set of bits to generate second products;
   a parity compare circuit coupled to the first multipliers and the second multipliers, wherein the parity compare circuit is configured to generate a parity compare signal indicating whether a number of ones in the first products and a number of ones in the second products have a same parity or different parities;
   a conversion circuit configured to change a bit value of one of the second products if the parity compare signal indicates the number of ones in the first products and the number of ones in the second products have the different parities;
   a first summer configured to sum the first products to generate a first sum;
   a second summer configured to sum the second products to generate a second sum;
   a switching circuit coupled to the first summer and the second summer;
   an analog-to-digital converter (ADC) coupled to the switching circuit; and
   a shift and add circuit coupled to the ADC.
2. The system of clause 1, wherein the conversion circuit is configured to change the bit value of the one of the second products from one to zero.
3. The system of clause 1 or 2, wherein the conversion circuit is configured to not change the bit value of the one of the second products if the parity compare signal indicates the number of ones in the first products and the number of ones in the second products have the same parity.
4. The system of any one of clauses 1 to 3, wherein:
   the switching circuit is configured to couple the first summer to the second summer to obtain an average of the first sum and the second sum; and
   the ADC is configured to convert the average of the first sum and the second sum into a digital signal.
5. The system of clause 4, wherein the shift and add circuit is coupled to the parity compare circuit, and the shift and add circuit is configured to:
   shift the digital signal to multiply the digital signal by two; and
   add a one to the shifted digital signal if the parity compare signal indicates the number of ones in the first products and the number of ones in the second products have the different parities.
6. The system of clause 5, wherein the shift and add circuit is configured to:
   not add the one to the shifted digital signal if the parity compare signal indicates the number of ones in the first products and the number of ones in the second products have the same parity.
7. The system of any one of clauses 4 to 6, wherein the shift and add circuit is coupled to the parity compare circuit, and the shift and add circuit is configured to:
   shift the digital signal to multiply the digital signal by two;
   output a one for a least significant bit (LSB) of the shifted digital signal if the parity compare signal indicates the number of ones in the first products and the number of ones in the second products have the different parities; and
   output a zero for the LSB of the shifted digital signal if the parity compare signal indicates the number of ones in the first products and the number of ones in the second products have the same parities.
8. The system of any one of clauses 1 to 7, wherein:
   each of the first products and the second products comprises 2⁽ⁿ⁻¹⁾ products, wherein n is an integer; and
   and the ADC has a bit resolution of n−1.
9. The system of any one of clauses 1 to 8, wherein:
   the first multipliers are configured to perform the multiplications on the first set of bits and the second set of bits to generate the first products during a first cycle of a clock signal; and
   the second multipliers are configured to perform the multiplications on the third set of bits and the fourth set of bits to generate the second products during a second cycle of the clock signal.
10. The system of clause 9, wherein the switching circuit is configured to:
   decouple the first summer and the second summer during the first cycle of the clock signal and during a first portion of the second cycle of the clock signal; and
   couple the first summer to the second summer during a second portion of the second cycle of the clock signal to obtain an average of the first sum and the second sum.
11. The system of clause 10, wherein the ADC is configured to convert the average of the first and the second sum into a digital signal.
12. The system of clause 11, wherein the shift and add circuit is coupled to the parity compare circuit, and the shift and add circuit is configured to:
   shift the digital signal to multiply the digital signal by two; and
   add a one to the shifted digital signal if the parity compare signal indicates the number of ones in the first products and the number of ones in the second products have the different parities.
13. The system of clause 12, wherein the shift and add circuit is configured to:
   not add the one to the shifted digital signal if the parity compare signal indicates the number of ones in the first products and the number of ones in the second products have the same parity.
14. The system of any one of clauses 1 to 13, wherein the first summer comprises a first capacitor array and the second summer comprises a second capacitor array.
15. A method for multiplication and accumulation, comprising:
   performing multiplications on a first set of bits and a second set of bits to generate first products;
   performing multiplications on a third set of bits and a fourth set of bits to generate second products;
   summing the first products to generate a first sum;
   changing a bit value of one of the second products;
   summing the second products to generate a second sum;
   averaging the first sum and the second sum to obtain an average of the first sum and the second sum;
   converting the average of the first sum and the second sum into a digital signal; and
   shifting and adding a one to the digital signal.
16. The method of clause 15, wherein changing the bit value of the one of the second products comprises changing the bit value of the one of the second products from one to zero.
17. The method of clause 15 or 16, further comprising determining a number of ones in the first products and a number of ones in the second products have different parities.
18. The method of clause 17, wherein changing the bit value of the one of the second products comprises changing the bit value of the one of the second products after a determination the number of ones in the first products and the number of ones in the second products have the different parities.
19. The method of any one of clauses 15 to 18, wherein shifting and adding the one to the digital signal comprises:
   shifting the digital signal by one bit position to multiply the digital signal by two; and
   outputting the one for a least significant bit (LSB) of the shifted digital signal.
20. The method of any one of clauses 15 to 19, wherein:
   summing the first products to generate the first sum comprises summing the first products to generate the first sum using a first summer; and
   summing the second products to generate the second sum comprises summing the second products to generate the second sum using a second summer.
21. The method of clause 20, wherein averaging the first sum and the second sum comprises coupling the first summer to the second summer to obtain the average of the first sum and the second sum.
22. The method of clause 21, wherein the first summer comprises a first capacitor array and the second summer comprises a second capacitor array.
23. A machine learning accelerator, comprising:
   a memory; and
   a multiply and accumulate array coupled to the memory, wherein the multiply and accumulate array includes multiply and accumulate circuits, and each of the multiply and accumulate circuits comprises:
   respective first multipliers configured to perform multiplications on a respective first set of bits and a respective second set of bits to generate respective first products;
   respective second multipliers configured to perform multiplications on a respective third set of bits and a respective fourth set of bits to generate respective second products;
   a respective parity compare circuit coupled to the respective first multipliers and the respective second multipliers, wherein the respective parity compare circuit is configured to generate a respective parity compare signal indicating whether a number of ones in the respective first products and a number of ones in the respective second products have a same parity or different parities;
   a respective conversion circuit configured to change a bit value of one of the respective second products if the respective parity compare signal indicates the number of ones in the respective first products and the number of ones in the respective second products have the different parities;
   a respective first summer configured to sum the respective first products to generate a respective first sum;
   a respective second summer configured to sum the respective second products to generate a respective second sum;
   a respective switching circuit coupled to the respective first summer and the respective second summer;
   a respective analog-to-digital converter (ADC) coupled to the respective switching circuit; and
   a respective shift and add circuit coupled to the respective ADC.
24. The machine learning accelerator of clause 23, wherein, for each of the multiply and accumulate circuits, the respective conversion circuit is configured to change the bit value of the one of the respective second products from one to zero.
25. The machine learning accelerator of clause 23 or 24, wherein, for each of the multiply and accumulate circuits, the respective conversion circuit is configured to not change the bit value of the one of the respective second products if the respective parity compare signal indicates the number of ones in the respective first products and the number of ones in the respective second products have the same parity.
26. The machine learning accelerator of any one of clauses 23 to 25, wherein the memory is coupled to an imaging device.
27. The machine learning accelerator of any one of clauses 23 to 26, further comprising a scale bias and non-linear circuit coupled to the multiply and accumulate array and the memory.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect electrical coupling between two structures.

Any reference to an element herein using a designation such as “first,” “second,” and so forth does not generally limit the quantity or order of those elements. Rather, these designations are used herein as a convenient way of distinguishing between two or more elements or instances of an element. Thus, a reference to first and second elements does not mean that only two elements can be employed, or that the first element must precede the second element.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A system comprising:
first multipliers configured to perform multiplications on a first set of bits and a second set of bits to generate first products;
second multipliers configured to perform multiplications on a third set of bits and a fourth set of bits to generate second products;
a parity compare circuit coupled to the first multipliers and the second multipliers, wherein the parity compare circuit is configured to generate a parity compare signal indicating whether a number of ones in the first products and a number of ones in the second products have a same parity or different parities;
a conversion circuit configured to change a bit value of one of the second products if the parity compare signal indicates the number of ones in the first products and the number of ones in the second products have the different parities;
a first summer configured to sum the first products to generate a first sum;
a second summer configured to sum the second products to generate a second sum;
a switching circuit coupled to the first summer and the second summer;
an analog-to-digital converter (ADC) coupled to the switching circuit; and
a shift and add circuit coupled to the ADC.

2. The system of claim 1, wherein the conversion circuit is configured to change the bit value of the one of the second products from one to zero.

3. The system of claim 1, wherein the conversion circuit is configured to not change the bit value of the one of the second products if the parity compare signal indicates the number of ones in the first products and the number of ones in the second products have the same parity.

4. The system of claim 1, wherein:
the switching circuit is configured to couple the first summer to the second summer to obtain an average of the first sum and the second sum; and
the ADC is configured to convert the average of the first sum and the second sum into a digital signal.

5. The system of claim 4, wherein the shift and add circuit is coupled to the parity compare circuit, and the shift and add circuit is configured to:
shift the digital signal to multiply the digital signal by two; and
add a one to the shifted digital signal if the parity compare signal indicates the number of ones in the first products and the number of ones in the second products have the different parities.

6. The system of claim 5, wherein the shift and add circuit is configured to:
not add the one to the shifted digital signal if the parity compare signal indicates the number of ones in the first products and the number of ones in the second products have the same parity.

7. The system of claim 4, wherein the shift and add circuit is coupled to the parity compare circuit, and the shift and add circuit is configured to:
shift the digital signal to multiply the digital signal by two;
output a one for a least significant bit (LSB) of the shifted digital signal if the parity compare signal indicates the number of ones in the first products and the number of ones in the second products have the different parities; and
output a zero for the LSB of the shifted digital signal if the parity compare signal indicates the number of ones in the first products and the number of ones in the second products have the same parities.

8. The system of claim 1, wherein:
each of the first products and the second products comprises 2⁽ⁿ⁻¹⁾ products, wherein n is an integer; and
and the ADC has a bit resolution of n−1.

9. The system of claim 1, wherein:
the first multipliers are configured to perform the multiplications on the first set of bits and the second set of bits to generate the first products during a first cycle of a clock signal; and
the second multipliers are configured to perform the multiplications on the third set of bits and the fourth set of bits to generate the second products during a second cycle of the clock signal.

10. The system of claim 9, wherein the switching circuit is configured to:
decouple the first summer and the second summer during the first cycle of the clock signal and during a first portion of the second cycle of the clock signal; and
couple the first summer to the second summer during a second portion of the second cycle of the clock signal to obtain an average of the first sum and the second sum.

11. The system of claim 10, wherein the ADC is configured to convert the average of the first and the second sum into a digital signal.

12. The system of claim 11, wherein the shift and add circuit is coupled to the parity compare circuit, and the shift and add circuit is configured to:
shift the digital signal to multiply the digital signal by two; and
add a one to the shifted digital signal if the parity compare signal indicates the number of ones in the first products and the number of ones in the second products have the different parities.

13. The system of claim 12, wherein the shift and add circuit is configured to:
not add the one to the shifted digital signal if the parity compare signal indicates the number of ones in the first products and the number of ones in the second products have the same parity.

14. The system of claim 11, wherein the first summer comprises a first capacitor array and the second summer comprises a second capacitor array.

15. A method for multiplication and accumulation, comprising:
performing multiplications on a first set of bits and a second set of bits to generate first products;
performing multiplications on a third set of bits and a fourth set of bits to generate second products;
summing the first products to generate a first sum;
changing a bit value of one of the second products;
summing the second products to generate a second sum;
averaging the first sum and the second sum to obtain an average of the first sum and the second sum;
converting the average of the first sum and the second sum into a digital signal; and
shifting and adding a one to the digital signal.

16. The method of claim 15, wherein changing the bit value of the one of the second products comprises changing the bit value of the one of the second products from one to zero.

17. The method of claim 15, further comprising determining a number of ones in the first products and a number of ones in the second products have different parities.

18. The method of claim 17, wherein changing the bit value of the one of the second products comprises changing the bit value of the one of the second products after a determination the number of ones in the first products and the number of ones in the second products have the different parities.

19. The method of claim 15, wherein shifting and adding the one to the digital signal comprises:
shifting the digital signal by one bit position to multiply the digital signal by two; and
outputting the one for a least significant bit (LSB) of the shifted digital signal.

20. The method of claim 15, wherein:
summing the first products to generate the first sum comprises summing the first products to generate the first sum using a first summer; and
summing the second products to generate the second sum comprises summing the second products to generate the second sum using a second summer.

21. The method of claim 20, wherein averaging the first sum and the second sum comprises coupling the first summer to the second summer to obtain the average of the first sum and the second sum.

22. The method of claim 21, wherein the first summer comprises a first capacitor array and the second summer comprises a second capacitor array.

23. A machine learning accelerator, comprising:
a memory; and
a multiply and accumulate array coupled to the memory, wherein the multiply and accumulate array includes multiply and accumulate circuits, and each of the multiply and accumulate circuits comprises:
respective first multipliers configured to perform multiplications on a respective first set of bits and a respective second set of bits to generate respective first products;
respective second multipliers configured to perform multiplications on a respective third set of bits and a respective fourth set of bits to generate respective second products;
a respective parity compare circuit coupled to the respective first multipliers and the respective second multipliers, wherein the respective parity compare circuit is configured to generate a respective parity compare signal indicating whether a number of ones in the respective first products and a number of ones in the respective second products have a same parity or different parities;
a respective conversion circuit configured to change a bit value of one of the respective second products if the respective parity compare signal indicates the number of ones in the respective first products and the number of ones in the respective second products have the different parities;
a respective first summer configured to sum the respective first products to generate a respective first sum;
a respective second summer configured to sum the respective second products to generate a respective second sum;
a respective switching circuit coupled to the respective first summer and the respective second summer;
a respective analog-to-digital converter (ADC) coupled to the respective switching circuit; and
a respective shift and add circuit coupled to the respective ADC.

24. The machine learning accelerator of claim 23, wherein, for each of the multiply and accumulate circuits, the respective conversion circuit is configured to change the bit value of the one of the respective second products from one to zero.

25. The machine learning accelerator of claim 23, wherein, for each of the multiply and accumulate circuits, the respective conversion circuit is configured to not change the bit value of the one of the respective second products if the respective parity compare signal indicates the number of ones in the respective first products and the number of ones in the respective second products have the same parity.

26. The machine learning accelerator of claim 23, wherein the memory is coupled to an imaging device.

27. The machine learning accelerator of claim 23, further comprising a scale bias and non-linear circuit coupled to the multiply and accumulate array and the memory.
